(19) United States
(12) Patent Application Publication
(10) Pub. No.: US 2018/0307462 A1
(43) Pub. Date: Oct. 25, 2018

(54) ELECTRONIC DEVICE AND METHOD FOR CONTROLLING ELECTRONIC DEVICE

(71) Applicant: SAMSUNG ELECTRONICS CO., LTD., Suwon-si (KR)

(72) Inventors: Hyung-tak CHOI, Suwon-si (KR); Deok-ho KIM, Seoul (KR); Dong-hyun KIM, Suwon-si (KR); Sung-ho KIM, Seoul (KR); Hyung-min CHO, Yongin-si (KR); In-chul HWANG, Seoul (KR)

(73) Assignee: SAMSUNG ELECTRONICS CO., LTD., Suwon-si (KR)

(21) Appl. No.: 15/768,453

(22) PCT Filed: Oct. 5, 2016
(86) PCT No.: PCT/KR2016/011114

§ 371 Date: Apr. 13, 2018

(30) Foreign Application Priority Data
Oct. 15, 2015 (KR) 10-2015-0144006

(51) Int. Cl. G06F 3/16; G10L 15/28; G06F 3/01

(52) U.S. Cl. CPC G06F 3/167; G10L 2015/223; G06F 3/01; G10L 15/28

(57) ABSTRACT

An electronic device includes at least one voice receiver provided at at least one area different from each other in the electronic device to receive voices of a plurality of utterers; a storage configured to store the received voices of the plurality of utterers; an information acquirer configured to acquire utterer information on the plurality of utterers; and a controller configured to store the received voices in the storage to match to the plurality of utterers and utterance locations of the plurality of utterers using directivities of the received voices.

### TECHNICAL FIELD

Apparatuses and methods consistent with exemplary embodiments relate to an electronic device, which can recognize a voice of an utterer, and a control methods thereof, and more particularly, an electronic device, which matches a voice to an utterer based on an utterance location and information of the utterer, and a control methods thereof.

### BACKGROUND ART

A voice recognition function, which is used in an electronic device, such as a smart phone, matches a voice to an utterer based on an utterance location of the utterer to recognize the voice.

### DISCLOSURE

### Technical Problem

However, if the electronic device or the utterer is changed in location during the voice recognition, it is impossible for the electronic device to recognize the voice by matching the voice to the utterer.

### Technical Solution

Accordingly, an electronic device, which can maintain a correspondence between an utterer and a voice before and after an utterance location is changed, and a control methods thereof are required.

In accordance with an aspect of an exemplary embodiment, there is provided an electronic device including: at least one voice receiver configured to receive voices of a plurality of utterers; a storage configured to store the received voices of the plurality of utterers; an information acquirer configured to acquire utterer information on the plurality of utterers who utters the voices, respectively; and a controller configured to store the received voices in the storage to match to the plurality of utterers, who utters corresponding voices, respectively, based on utterance locations of the plurality of utterers and the utterer information acquired by the information acquirer. With this, the device may maintain a correspondence between the utterers and the voices before and after the utterance locations are changed.

The at least one voice receiver may be provided at at least one area different from each other in the electronic device. Thus, the changed utterance locations may be accurately measured.

The controller may be configured to identify the utterance locations of the plurality of utterers using directivities of the voices received by the at least one voice receiver. Thus, the changed utterance locations may be accurately measured.

The controller may be configured to correct the utterance locations in response to determining that the utterance locations are changed. Thus, the correspondence between the utterers and the voices before and after the utterance locations are changed may be maintained.

The controller may be configured to, in response to utterer information different from the acquired utterer information being acquired, add an utterer corresponding to the different utterer information. Thus, the correspondence between the utterers and the voices before and after the utterance locations are changed may be maintained.

The controller may be configured to identify an utterance location of the added utterer corresponding to the different utterer information, and store a voice of the added utterer in the storage to match to the added utterer based on the utterance location of the added utterer and the different utterer information. Thus, the correspondence between the utterers and the voices before and after the utterance locations are changed may be maintained.

The controller may be configured to, in response to the utterance locations of the plurality of utterers being changed due to the added utterer, correct the utterance locations of the plurality of utterers. Thus, the correspondence between the utterers and the voices before and after the utterance locations are changed may be maintained.

In accordance with an aspect of another exemplary embodiment, there is provided a control method of an electronic device including: receiving voices of a plurality of utterers; storing the received voices of the plurality of utterers; acquiring utterer information on the plurality of utterers who utters the voices, respectively; and storing the received voices to match to the plurality of utterers, who utters corresponding voices, respectively, based on utterance locations of the plurality of utterers and the acquired utterer information, to store the matched results.

The receiving may include receiving the voices of the plurality of utterers at least one area different from each other in the electronic device. Thus, the utterance locations of the plurality of utterers may be identified.

The storing may include identifying the utterance locations of the plurality of utterers using directivities of the received voices. Thus, the utterance locations of the plurality of utterers may be more accurately identified.

The storing may include correcting the utterance locations in response to determining that the utterance locations are changed.

The storing may include adding, in response to utterer information different from the acquired utterer information being acquired, an utterer corresponding to the different utterer information.

The adding may include identifying an utterance location of the added utterer corresponding to the different utterer information, and storing a voice of the added utterer to match to the added utterer based on the utterance location of the added utterer and the different utterer information.

The storing the voice of the added utterer to match to the added utterer may include correcting, in response to the utterance locations of the plurality of utterers being changed due to the added utterer, the utterance locations of the plurality of utterers.

In accordance with an aspect of other exemplary embodiment, there is provided a computer readable recording medium including a program for executing a control method of an electronic device, the control method of the electronic device including: receiving voices of a plurality of utterers; storing the received voices of the plurality of utterers; acquiring utterer information on the plurality of utterers who utters the voices, respectively; and storing the received voices to match to the plurality of utterers, who utters corresponding voices, respectively, based on utterance locations of the plurality of utterers and the acquired utterer information.

### Advantages Effects

According to the exemplary embodiments, the electronic device, which can maintain the correspondence between the utterers and the voices before and after the utterance locations are changed, and the control methods thereof may be provided.

### DESCRIPTION OF DRAWINGS

FIG. 1 is a block diagram illustrating an electronic device according to an exemplary embodiment;

FIG. 2 is a front view of the electronic device illustrated in FIG. 1;

FIG. 3 is a view illustrating a method where a microphone according to an exemplary embodiment estimates a direction and/or a location of a sound source;

FIG. 4 is a view illustrating a process of correcting an utterance location;

FIG. 5 is a view illustrating a process of converting a voice into a text;

FIG. 6 is a flowchart illustrating a process of receiving a voice;

FIG. 7 is a flowchart illustrating a process of storing and reproducing a voice;

FIG. 8 is a flowchart illustrating a process of storing and reproducing a voice according to a related art;

FIGS. 9 to 14 are views or flow charts illustrating a process where the electronic device according to an exemplary embodiment stores and reproduces a voice;

FIG. 15 is a flowchart illustrating a method of creating a minute; and

FIG. 16 is a view schematically illustrating a smart network system including an electronic device according to an exemplary embodiment.

### BEST MODE

Below, exemplary embodiments will be described in detail with reference to accompanying drawings. In the following description and accompanying drawings, descriptions of well-known functions and constructions, which can cloud the gist of the present disclosure, may be omitted for clarity and conciseness. Also, since terms, which will be described later, are defined taking account of functions in the present disclosure, they may vary according to users, intentions of operators, practices and the like. Thus, definitions of the terms should be determined based on contents over all of the present disclosure.

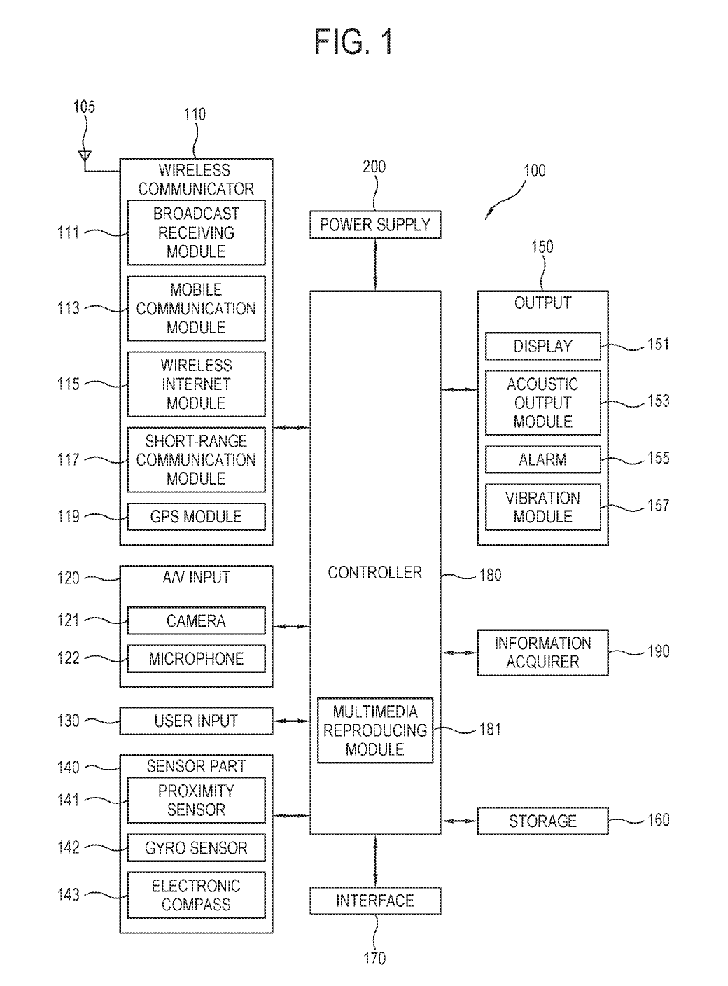

FIG. 1 is a block diagram illustrating an electronic device 100 according to an exemplary embodiment. The electronic device 100 may be a portable electronic device. The electronic device 100 may also be an apparatus, such as a portable terminal, a mobile phone, a mobile pad, a media player, a tablet computer, a smart phone or a personal digital assistant (PDA). Also, the electronic device 100 may be any portable electronic device including a device in which more than two functions are combined from among the apparatuses as described above.

Referring to FIG. 1, the electronic device 100 may include a wireless communicator 110, an audio/video (A/V) input 120, a user input 130, a sensor part 140, an output 150, a storage 160, an interface 170, a controller 180, and a power supply 200. When being implemented in practical applications, the components may be configured in such a manner that more than two components are incorporated into one component or one component is subdivided into more than two components on occasion demands.

The wireless communicator 110 may include a broadcast receiving module 111, a mobile communication module 113, a wireless internet module 115, a short-range communication module 117, a global positioning system (GPS) module 119, etc.

The broadcast receiving module 111 receives at least one of a broadcast signal and broadcasting related information via broadcasting channels from an external broadcasting management server. Here, the broadcasting channels may include satellite channels, terrestrial channels and so on. The external broadcasting management server may refer to a server, which receives the at least one of the broadcast signal and the broadcasting related information and transmits them to the electronic device 100. The broadcasting related information may include information related to broadcasting channels, broadcasting programs, broadcasting service providers, and so on. The broadcast signal may include a television (TV) broadcast signal, a radio broadcast signal, a data broadcast signal, and a broadcast signal in which at least two broadcast signals are combined from among the broadcast signals as described above. The broadcasting related information may be also provided via a mobile communication network and in this case, may be receives via the mobile communication module 113. The broadcasting related information may exist in various types. For example, the broadcasting related information may exist in the form of an electronic program guide (EPG) of digital multimedia broadcasting (DMB), an electronic service guide (ESG) of digital video broadcast-handheld (DVB-H), or the like.

The broadcast receiving module 111 receives the broadcast signal using all kind of broadcasting systems. In particular, the broadcast receiving module 111 may receive the broadcast signal via digital broadcasting systems, such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), etc. The broadcast signal and the broadcasting related information received via the broadcast receiving module 111 may be stored in the storage 160.

The mobile communication module 113 receives and transmits a wireless signal with at least one of a base station, an external terminal and a server over a mobile communication network. Here, the wireless signal may include a voice signal, a videotelephony call signal, or data in various type according to transmission and reception of text/multimedia messages.

The wireless internet module 115, which refers to a module for wireless internet connection, may be equipped inside or outside the electronic device 100. The short-range communication module 117 refers to a module for short-range communication. The short-range communication module 117 may use short-range communication technologies, such as Bluetooth, radio frequency identification (RFID), infrared data association (IrDA), ultra wideband (UWB), ZigBee, etc. The GPS module 119 receives position information from a plurality of GPS satellites.

The A/V input 120, which receives an audio signal or a video signal, may include a camera 121, a microphone 122 and so on.

The camera 121 processes image frames for a still image, a motion image or the like acquired by an image sensor in a video call mode, a scene mode or a minute creation mode. The processed image frames may be displayed on a display 151, stored in the storage 160 or transmitted to the external via the wireless communicator 110. The camera 121 may include more than two cameras depending on device configuration. For example, two cameras may be provided at a front side or a rear side of the electronic device 100, respectively.

The microphone 122 receives and processes an external acoustic signal to convert into electric voice data in a call mode, a recording mode, a voice recognition mode, or a minute creation mode. In the call mode, the processed voice data may be converted and outputted in a form transmittable to the mobile communication base station through the mobile communication module 113. In the voice recognition mode, text messages corresponding to the processed voice data may be displayed on the display 151 and in the minute creation mode, text data corresponding to the processed voice data may be stored in the storage 160. The microphone 122 may use various noise rejection algorithms for removing noises, which occur in the course of receiving the external acoustic signal.

The user input 130 generates key input data, which is inputted by the user for controlling operations of the device. The user input 130 may be configured as a key pad, a touch pad, a jog wheel, a jog switch, a finger mouse, etc. In particular, if the touch pad constitutes a mutually-layered structure with the display 151 to be described later, it may be called a touch screen.

The sensor part 140 senses current states of the electronic device 100, such as open and close state of the electronic device 100, location of the electronic device 100, moving state of the electronic device 100, contact with the user, etc. to generate sensing signals for controlling operations of the electronic device 100. For example, the sensor part 140 may sense whether the electronic device 100 is lying on a table, or moving with the user. Also, the sensor part 140 may charge functions associated with sensing whether the power supply 200 supplies power, whether the interface 170 is connected with external devices and the like.

The sensor part 140 may include a proximity sensor 141. The proximity sensor 141 detects whether there is any object, which approaches thereto or by which is close without mechanical contact. The proximity sensor 141 may detect close objects using a change in alternating current magnetic field or static magnetic field, or a rate of change in electrostatic capacity. The proximity sensor 141 may include more than two proximity sensors according to device configuration.

The sensor part 140 may include a gyro sensor 142 or an electronic compass 143. The gyro sensor 142 may sense a direction where the electronic device 100 moves using a gyroscope to output as an electric signal. Also, since the electronic compass 143 is coordinated according to earth's magnetic field by a magnetic sensor, the electronic compass 143 may sense the direction of the electronic device 100.

The output 150, which outputs an audio signal and a video signal, may include a display 151, an acoustic output module, an alarm 155, a vibration module 157, etc.

The display 151 displays information processed by the electronic device 100. For example, in the call mode, the voice recognition mode, the minute creation mode and the like, the display 151 may display a user interface (UI) or a graphic user interface (GUI), which is related with call, voice recognition, minute creation and the like, respectively.

If the display 151 is configured as the touch screen, the display 151 may include a touch screen panel, which can be used as the input as well as the output. The touch screen panel as a transparent panel attached to the outside may be connected to an internal bus of the electronic device 100. If there is a touch input from the user, the touch screen panel transmits a corresponding signal to the controller 180 thus to allow the controller 180 to knew whether there is the touch input and which area is touched on the touch screen.

Further, the display 151 may include at least one of a liquid crystal display, a thin film transistor-liquid crystal display, an organic light-emitting diode, a flexible display, or a three dimensional (3D) display. Also, depending on implementation types of the electronic device 100, more than two displays 151 may be provided. For example, the two displays 151 may be provided at a front side and a rear side of the electronic devise 100, respectively.

The acoustic output module 153 outputs voice data received from the wireless communicator 110 or stored in the storage 160 in the call mode, the recording mode, the voice recognition mode, the broadcast receiving mode, the minute creation mode, etc. The acoustic output module 153 outputs acoustic signals corresponding to, for example, a call signal-receiving sound, a message receiving sound and the like, which are related with functions performed by the electronic device 100. The acoustic output module 153 may include a speaker, a buzzer and so on.

The alarm 155 outputs a signal for notifying that any event occurs in the electronic device 100. As examples of events which occur in the electronic device 100, there are a call signal reception, a message reception, a key signal input, etc. The alarm 155 outputs a signal for notifying that any event occurs in other form besides the audio signal or the video signal.

The vibration module 157 may generate various vibrations in strength and pattern by a vibration signal transmitted by the controller 180. Strength, pattern frequency, moving direction, moving speed and the like of the vibration generated by the vibration module 157 may be set up by the vibration signal. Depending on device configuration, more than two vibration modules 157 may be provided.

The storage 160 stores programs processed or controlled by the controller 180 and various data inputted and outputted by the programs. The storage 160 may include a storing medium of at least one type from among a flash memory type, a hard disk type, a multimedia card micro type, a card type (for example, a secure digital (SD) card type, a xD-picture (XD) card type or the like), a RAM, or a ROM. Also, the electronic device 100 may operate a web storage, which performs a storage function over the internet.

The interface 170 performs an interface role with all of external devices, which are connected with the electronic device 100. As examples of the external devices connected with the electronic device 100, there are a wired or wireless headset, an external battery charger, a wired or wireless data port, a memory card, a card socket, such as a SIM/UIM card, an audio input/output (I/O) terminal, a video I/O terminal, an earphone, etc. The interface 170 may receive data or be supplied with power from the external devices to transmit to respective components in the electronic device 100, and transmit data to the external devices from the respective components in the electronic device 100.

The controller 180 is configured as a processor, which generally controls operations of the respective components in the electronic device 100. The controller 180 controls components related with voice call, data communication, video call, voice recording, minute creation, etc. or processes data related therewith. Also, the controller 180 may be provided with a multimedia reproducing module 181 for reproducing multimedia. The multimedia reproducing module 181 may be configured as a hardware in the controller 180 or a software separate from the controller 180.

An information acquirer 190 may analyze voices received through the microphone 122 from a plurality of utterers thus to obtain utterer information corresponding to unique voice frequency bands and types of sound wave that the utterers have, respectively. Under control of the controller 180, the power supply 200 is supplied with external power and/or internal power to provide power required to operate respective components.

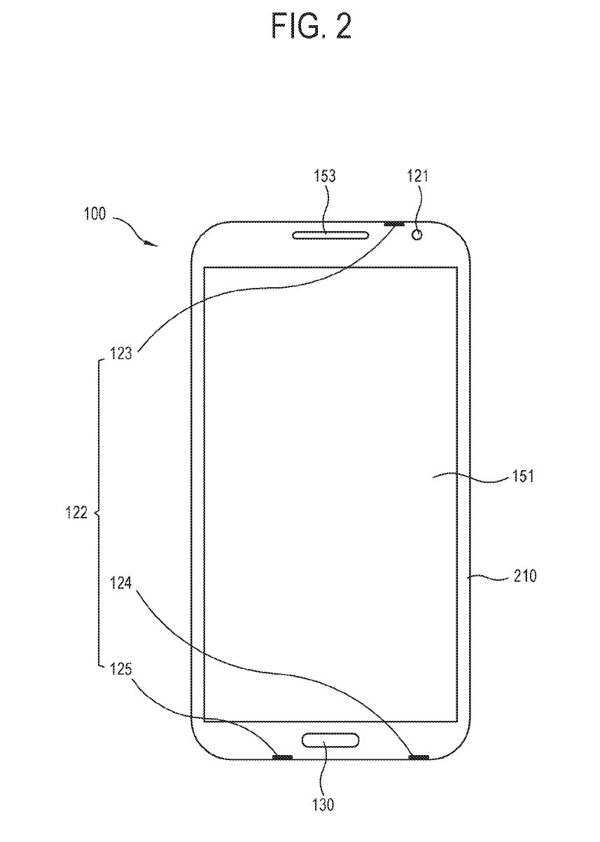

Hereinafter, configuration to external form of the electronic device 100 according to an exemplary embodiment will be described in detail with reference to FIG. 2. For the sake of explanation, a bar type electronic device with which a front touch screen is provided is explained by way of an example from among electronic devices of various types, such as a folder type, a bar type, a swing type, a slider type, etc. However, the present disclosure is not limited to the bar type electronic device and may be applied to electronic devices of all types including the types as described above.

FIG. 2 is a front view of the electronic device 100 illustrated in FIG. 1. Referring to FIG. 2, the electronic device 100 includes a case 210, which forms an appearance of the electronic device 100. The case 210 may have at least one intermediate case additionally disposed therein. The cases may be formed extruding synthetic resin or formed of metal material, such as stainless steel (STS), titanium (Ti) or the like.

At a front side of the case 210 may be disposed a display 151, a first camera 121, a first microphone 123, a second microphone 124, a third microphone 125, a first speaker 153 and a user input 130. In some cases, at a rear side of the case 210 may be disposed a second camera and a second speaker.

The display 151 includes a liquid crystal display (LCD), an organic light emitting diode (LCD) or the like, which visually displays information. Further, the display 151 may be also configured to operate as a touch screen, so that the information can be inputted by user's touch.

The first camera 121 may be implemented to be suitable to capture an image or a motion image to the user or the like. The user input 130 may employ whichever tactile manner the user manipulates while feeling a sense of touch. A plurality of microphones 122 may be implemented in a form suitable to receive a voice of the user, all sorts of sounds, etc.

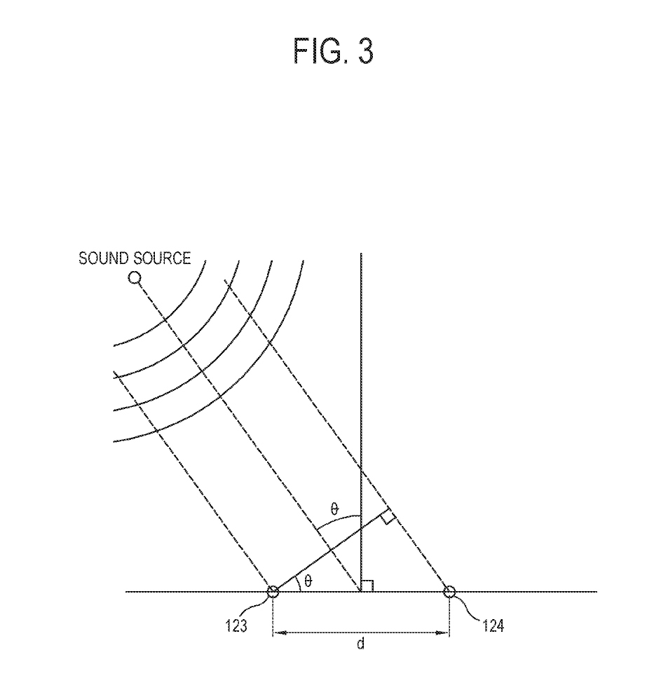

FIG. 3 is a view illustrating a method where the microphone 122 estimates a direction and/or a location of a sound source. The electronic device 100 according to an exemplary embodiment may include a voice receiver 122 composed of a plurality of microphone 122. The direction of the sound source may be estimated using a device, such as a directional microphone. However, with one directional microphone, it is possible only to identify the direction of the sound source and difficult to identify the location and distance of the sound source.

Accordingly, to identify the location and/or distance of the sound source, the plurality of microphone 122 is used. There are various ways, which identify the location and/or distance of the sound source using the plurality of microphone 122, but FIG. 3 illustrates how to estimate the location and/or distance of the sound source using delayed time of arrival and occurrence of sound source in two dimensional space.

Referring to FIG. 3, it is assumed that a sound generated from a sound source located on a specific point is planarly inputted into two microphones 123 and 124. The sound (sound wave) first arrives at the first microphone 123 more close by the sound source and then the second microphone 124 a delayed time of arrival t later. A direction of the sound source may be found by calculating an angle θ among the two microphones 123 and 124 and the sound source. A difference ΔS between a sound wave path distance from the sound source to the first microphone 123 and a sound wave path distance from the sound source to the second microphone 124 may be expressed as follow.

ΔS=t*V(v is a speed of sound wave)=d*sin θ (d is a separation distance between the first microphone 123 and the second microphone 124)

That is, the following formula is established.

$$θ = arcsin \frac{τ * v}{d}$$

Accordingly, if the delayed time of arrival t is found from the above formula, the direction of the sound source may be estimated. By analyzing each of signals inputted into the two microphones 123 and 124, t may be analyzed out.

If to apply a basic principle illustrated in FIG. 3 on a three dimensional space, increasing the number of microphones included in a microphone array, the present disclosure may be also applied to the three dimensional space. Furthermore, if enough microphones are secured, a location of sound source (a distance to the sound source) may be estimated as well as the direction of sound source on the three dimensional space.

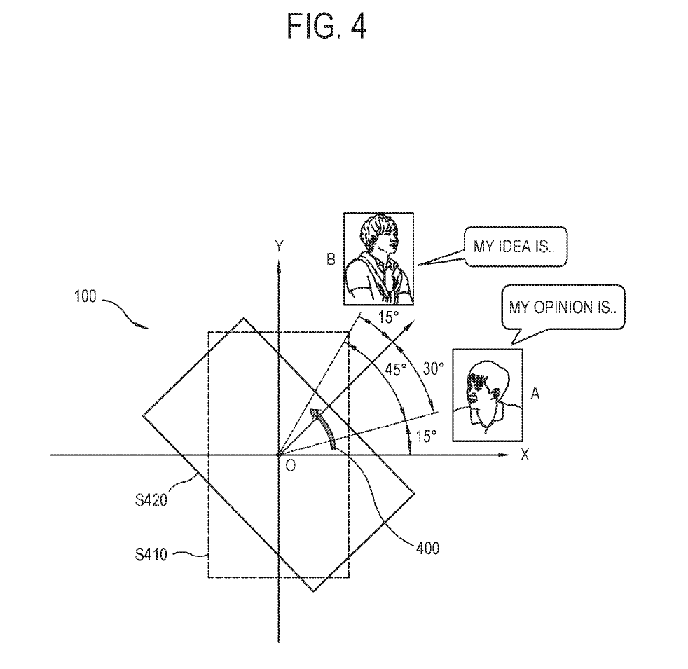

FIG. 4 is a view illustrating a process of correcting an utterance location. In the voice recognition mode or the minute creation mode, the electronic device 100 may receive voices uttered by a plurality of utterers through the voice receiver 122 including the plurality of microphones. In particular, in a conference where the plurality of utterers attends, the electronic device 100 may separate and store the voices uttered by the plurality of utterers according to utterers.

The voice receiver 122 may be provided at areas different from each other in the electronic device 100 to receive the voices from the plurality of utterers. Since the voice receiver 122 may be provided with at least one microphone, the voice receiver 122 may estimate utterance directions and utterance locations of uttered voices.

Based on the voices of the plurality of utterers received by the voice receiver 122, the information acquirer 190 may acquire utterer information by utterers according to unique voice frequency bands and types of sound wave that the utterers have, respectively.

Based on utterance locations of the plurality of utterers identified using directivities of the voices received by the voice receiver 122 and the utterer information acquired by the information acquirer 190, the electronic device 100 may store the received voices in the storage 160 matching to the plurality of utterers who utters corresponding voices, respectively.

Referring to FIG. 4, in a first state S410, the electronic device 100 is placed on a X-Y plane, and an utterer A and an utterer B are positioned at an utterance location A (for example, 15 degrees) and an utterance location B (for example, 60 degrees) from an axis X with respect to a center of the electronic device 100, respectively. The controller 180 of the electronic device 100 may find the utterance locations A and B of the utterers A and B based on directivities of voices of the utterers A and B received by the voice receiver 122.

Also, the information acquirer 190 of the electronic device 100 may acquire utterer information A about the utterer A based on a voice uttered by the utterer A. For example, the information acquirer 190 acquires the utterer information A about the utterer A based on a unique voice frequency band and a unique type of sound wave of the utterer A. Likewise, the information acquirer 190 utterer information B about the utterer B.

Accordingly, the controller 180 matches the utterance location A to the utterer information A and stores a voice received from the utterance location A as a voice of the utterer A. Likewise, the controller 180 matches the utterance location B to the utterer information B and stores a voice received from the utterance location B as a voice of the utterer B.

As described above, the controller 180 may separate and store the voices received through the voice receiver 122 according to utterers in the storage 160 and the stored voices may be reproduced by the acoustic output 153 according to an input inputted through the user input 130 from the user.

Further, the controller 180 may convert the separated and stored voices into text files and store the converted text files in the storage 160. The text conversion is performed in real time, and the separated voices are converted to insert the utterer information therein. The utterer information is information about the utterers and, for example, in the converted text files may be inserted utterer's names or the like. The text files may be displayed on the display 151 of the electronic device 100 according to an input inputted through the user input 130 from the user, or transmitted in the form of a short message service (SMS) and multimedia messaging service (MMS) to external devices.

Also, the controller 180 may arrange and store the text files by created times according to an input inputted through the user input 130 from the user.

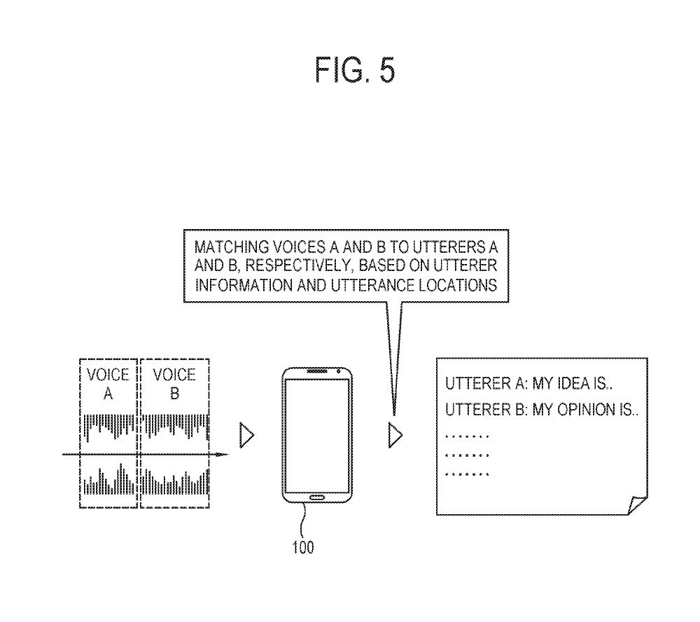

FIG. 5 is a view illustrating a process of converting a voice into a text. Referring to FIG. 5, the controller 180 may separate voices A and B of utterers A and B and convert the divided voice A and B into text files. At this time, the utterers of the voices are analyzed using utterer information, and the utterers, which correspond to the analyzed utterer information are presented in texts.

The utterer information is table values for voice frequency bands and types of sound wave of utterers provided in advance. If the voice frequency bands and the types of sound wave of the utterers provided in advance are coincided with voice frequency bands and types of sound wave of the separated voices, utterer information included in the table values is converted into and presented in texts.

However, in most cases, since the utterer information is not provided in advance, it will not come to know who the utterers are. At this time, the controller 180 identifies utterance locations of the utterers using the directivities of the received voices and matches the received voices to utters, which utter corresponding voices, based on the identified utterance locations and the utterer information.

In a related art, since utterers are identified according to an order where voices are received through the voice receiver 122, an accuracy in separating the voices of the utterers is low. However, the electronic device 100 according to an exemplary embodiment takes account of even the utterance locations of the utterers, thereby increasing the accuracy in dividing the voices of the utterers.

Referring again to FIG. 4 to explain the problem of the related art in more detail, if the related art electronic device 100 is changed in location or angle, utterers should be identified according to an order where voices are received after the change and thus it was uncertain whether voices of the utterers separated before the change are identical to voices of the utterers separated after the change.

For example, according to the related art, in the first state S410, the related art electronic device 100 stores voices of utterers A and B to match to utterer information A and B, respectively, according to an order where the voices are received thereto. As in a second state S420, if the electronic device 100 is rotated counterclockwise in an angle of 45 degrees after a preset time elapses, unique voice frequency bands and types of sound wave of the utterers vary. Thus, the related art electronic device 100, which does not take account of the rotation, recognizes voices of the utterers A and B received after the rotation as voices of new utterers C and D, respectively, and stores the voices of the utterers A and B as the voices of the utterers C and D, respectively, thereby resulting in severance and discontinuity of voice separation.

However, according to an exemplary embodiment, in the first state S410, the controller 180 of the electronic device 100 identifies utterance locations A and B based on directivities of voices of the utterers A and B, respectively, and stores matching the voices of the utterers A and B to the utterers A and B based on the identified utterance locations A and B and utterer information A and B, respectively. As in a second state S420, even if the electronic device 100 is rotated counterclockwise in an angle of 45 degrees as and thus unique voice frequency bands and types of sound wave of the utterers vary, the controller 180 may correct the utterance locations A and B to accommodate the rotated angle, thereby maintain continuity of voice separation.

In other words, since in the first state S410, the electronic device 100 receives the voice of the utterer B from a direction in a positive angle of 60 degrees from the axis X, the utterance position B has corresponded to the direction in the positive angle of 60 degrees. However, since in the second state S420, the electronic device 100 receives the voice of the utterer B from a direction in a positive angle of 15 degrees from the axis X, the utterance position B is corrected to correspond to the direction in the positive angle of 15 degrees.

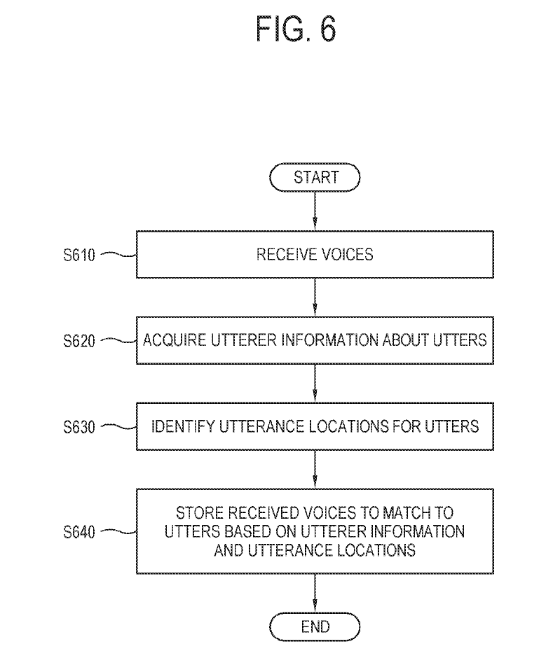

FIG. 6 is a flowchart illustrating a process of receiving a voice. Referring to FIG. 6, the process may include receiving voices of a plurality of utterers by the voice receiver 190 of the electronic device 100 (S610), acquiring utterer information about the plurality of utterers who utters the voices based on the received voices by the information acquirer 190 of the electronic device 100 (S620), identifying utterance locations of the plurality of utterers based on the received voices by the controller 180 of the electronic device 100 (S630), and storing the received voices to match to the plurality of utterers, which utter corresponding voices, respectively, based on the identified utterance locations and the acquired utterer information by the controller 180, to store in the storage 160 (S640). With this, the voices uttered by the plurality of utterers may be separated and stored according to utterers. Here, even if the electronic device 100 is changed in location and angle and thus the utterance locations of the plurality of utterers vary, the controller 180 may correct the utterance locations of the plurality of utterers to accommodate the changed location or angle.

On the other hand, the present disclosure may be implemented as a computer readable recording medium in which a program for performing a control method of the electronic device 100 is recorded, the program including receiving voices of a plurality of utterers; storing the voices of the plurality of utterers; acquiring utterer information about the plurality of utterers who utters the voices, respectively; and storing the received voices to match to the plurality of utterers, which utter corresponding voices, respectively, based on utterance locations of the plurality of utterers and the acquired utterer information.

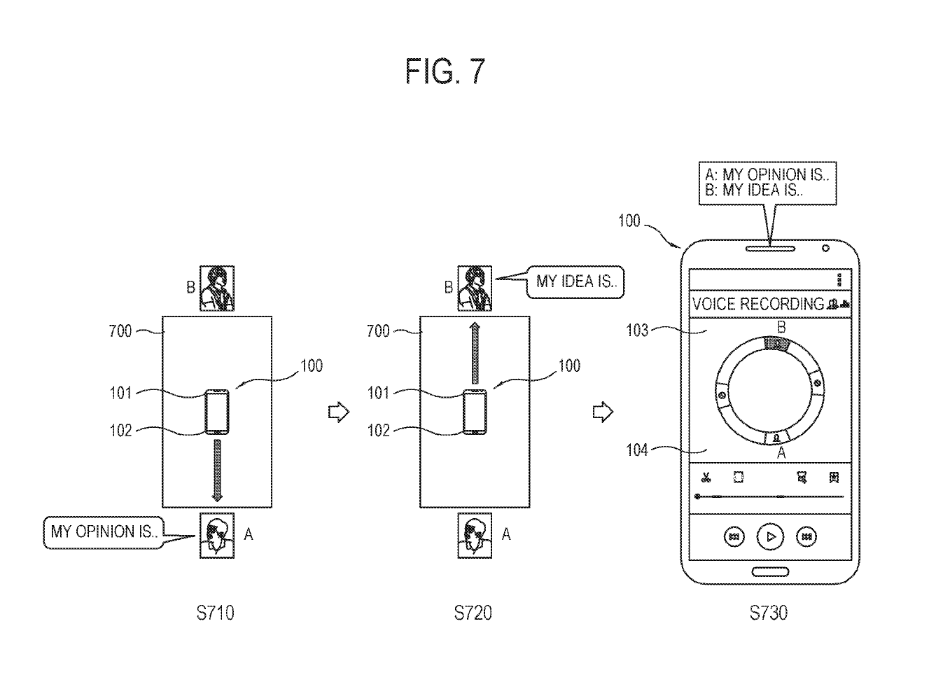

FIG. 7 is a flowchart illustrating a process where the electronic device 100 stores and reproduces a voice. Referring to FIG. 7, it is assumed that the electronic device 100 is set up in the voice recognition mode or the minute creation mode according to an input through the user input 130 from the user and upper side 101 and lower side 102 of the electronic device 100 are placed on a table 700 to face utterers B and A, respectively. Accordingly, the electronic device 100 may acquire utterance locations and utterer information based on voices of the utterers A and B, and separate and store the received voices according to utterers based on the acquired utterance locations and utterer information.

For example, if the voice receiver 122 receives a voice of the utterer A located toward the lower side 102 of the electronic device 100, the information acquirer 190 acquires utterer information A of the utterer A based on a voice frequency band and a type of sound wave of the utterer A. The controller 180 identifies a utterance location A using a directivity of the voice of the utterer A, and stores the voice of the utterer A in the storage 160 to match to the utterer A based on the identified utterance location A and the acquired utterer information A (S710). In the same manner, the controller 180 matches a voice of the utterer B to the utterer B to store in the storage 160 (S720). Accordingly, in the voice recognition mode or the minute creation mode, the electronic device 100 may separate received voices according to utterers and store the separated voices as minutes in the storage 160.

Here, the electronic device 100 may execute a minute reproducing mode for reproducing the minutes stored in the storage 160 according to an input inputted through the user input 130 from the user (S730). If an application corresponding to the minute reproducing mode is executed by the user, a list about a plurality of stored minutes is displayed, and if a minute the user wants to reproduce is selected from the list, a screen, which indicates the utterance locations of the utterers, is displayed on the display 151. In other words, since in the minute creation mode, the utterer B and the utterer A have been located toward the upper side 101 and the lower side 102 of the electronic device 100, respectively, the controller 180 controls the display 151 to display an icon B corresponding to the utterer B and an icon A corresponding to the utterer A on upper end 103 and lower end 104 of the display 151, respectively. When the voice of the utterer A is reproduced, the controller 180 may control the display 151 to display the icon A corresponding to the utterer A to flicker or be distinguished from icons corresponding to other utterers. Also, when the voice of the utterer B is reproduced, the controller may control the display 151 to display the icon B corresponding to the utterer B to be distinguished from icons corresponding to other utterers.

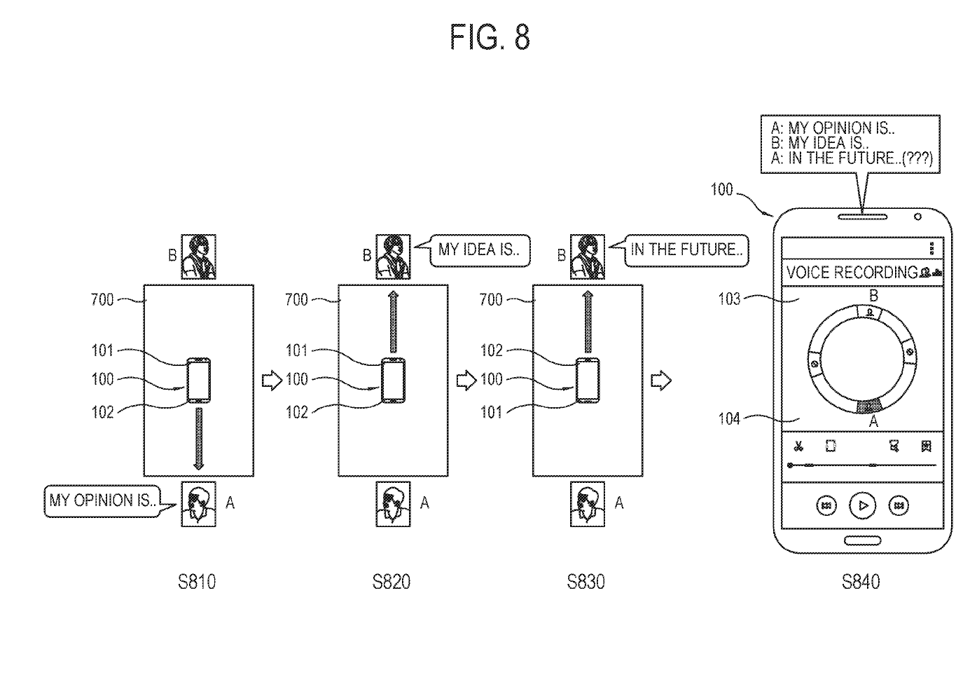

FIG. 8 is a flowchart illustrating a process of storing and replaying a voice according to a related art. Referring to FIG. 8, in a minute creation mode, the upper side 101 and the lower side 102 of the electronic device 100 are placed on a table 700 to face utterers B and A, respectively, as in FIG. 7. Accordingly, the electronic device 100 may acquire utterance locations and utterer information based on voices of the utterers A and B, and separate and store the voices according to utterers based on the acquired utterance locations and utterer information (S810, S820).

However, in the process of the minute creation mode, the upper side 101 and the lower side 102 of the electronic device 100 are upside down to rotate the electronic device 100 in an angle of 180 degree, utterance locations and utterer information after the rotation are not coincided with the utterance locations and utterer information before the rotation, so that voices separated by utterers after the rotation come different from voices separated by utterers before the rotation (S830). In other words, since after the rotation of the electronic device 100, a voice of the utterer B is received to the lower side 102 of the electronic device 100, the received voice of the utterer B is separated into and stored as a voice of the utterer A. Accordingly, in the minute reproducing mode, a malfunction occurs in that while the voice of the utterer B after the rotation is reproduced, an icon A of the utterer A flickers or is displayed on the display 151.

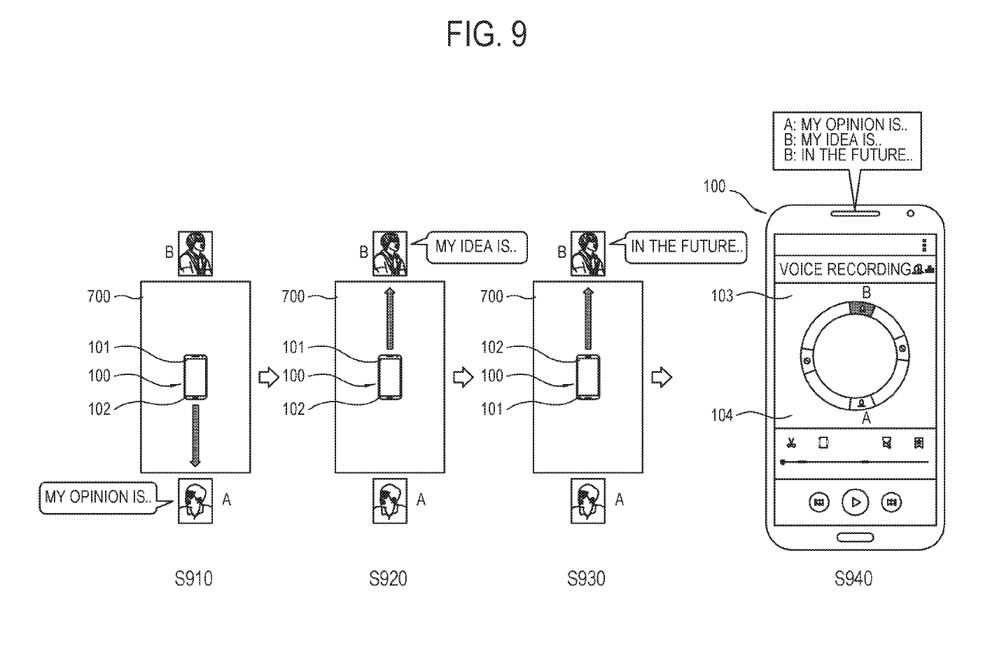

FIGS. 9 to 14 are views or flow charts illustrating a process where the electronic device 100 stores and reproduces a voice. Referring to FIG. 9, as in FIG. 8, the electronic device 100 separates and stores received voices according to utterers based on utterance locations and utterer information of the utterers A and B (S910, S920). In other words, a voice received to the lower side 102 of the electronic device 100 is stored as a voice of the utterer A and a voice received to the upper side 101 of the electronic device 100 is stored as a voice of the utterer B. At this time, after the upper side 101 and the lower side 102 of the electronic device 100 are upside down to rotate the electronic device 100 in an angle of 180 degree, a voice uttered by the utterer B is a voice received to the lower side 102 of the electronic device 100. Accordingly, the controller 108 corrects an utterance location B of the utterer B to accommodate the rotation of 180 degree, so that the utterance location B of the utterer B comes to be located toward the lower side 102 of the electronic device 100. Likewise, the controller 180 corrects an utterance location B of the utterer B. After the correction, the controller 180 separates voices received to the lower side 102 and the upper side 101 of the electronic device 100 into voices of the utterers B and A and stores the separated voices as minutes of the utterers B and A in the storage 160.

Accordingly, in the minute reproducing mode, if a minute is selected and reproduced from the stored minutes, an icon A corresponding to the utterer A is displayed on the display 151 to be distinguished from icons corresponding to other utterers when the voice of the utterer A is reproduced, without severance and discontinuity of voice separation.

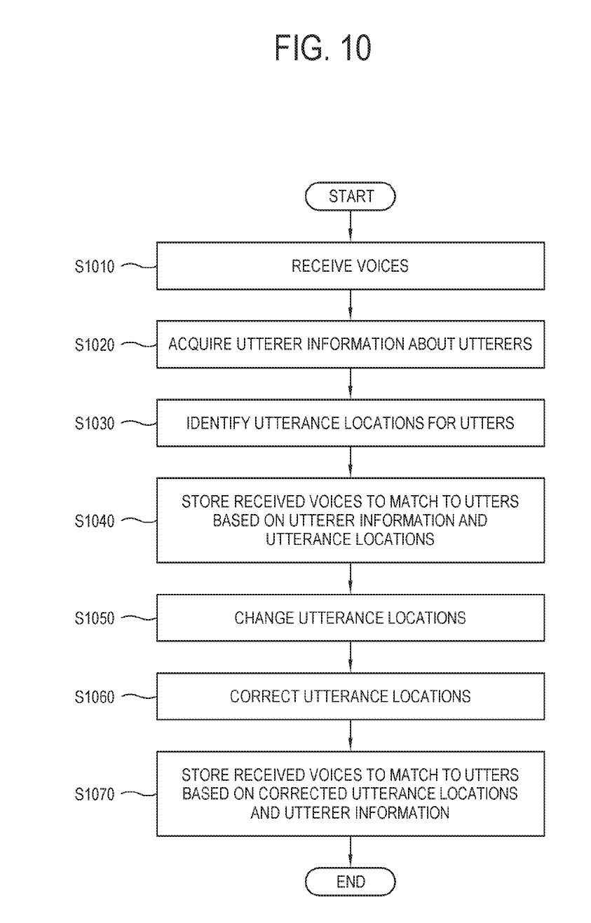

Referring to FIG. 10, the voice receiver 122 receives voices of a plurality of utterers (S1010). The information acquirer 190 acquires utterer information about the plurality of utterers based on the received voices (S1020). The controller 180 identifies utterance locations for the plurality of utterers based on the received voices (S1030). Also, the controller 180 stores the received voices in the storage 160 to match to the plurality of utterers, which utters corresponding voices, respectively, based on the identified utterance locations and the acquired utterer information (S1040). However, if the electronic device 100 is changed in location or rotated and thus the utterance locations of the plurality of utterers vary, the controller 180 corrects the utterance locations (S1060), and stores received voices in the storage to match to utterers who utter corresponding voices, respectively, based on the corrected utterance locations and the utterer information (S1070). Accordingly, the voices received before and after the utterance locations of utterers are changed may be stored to match to the utterers who utter corresponding voices, respectively.

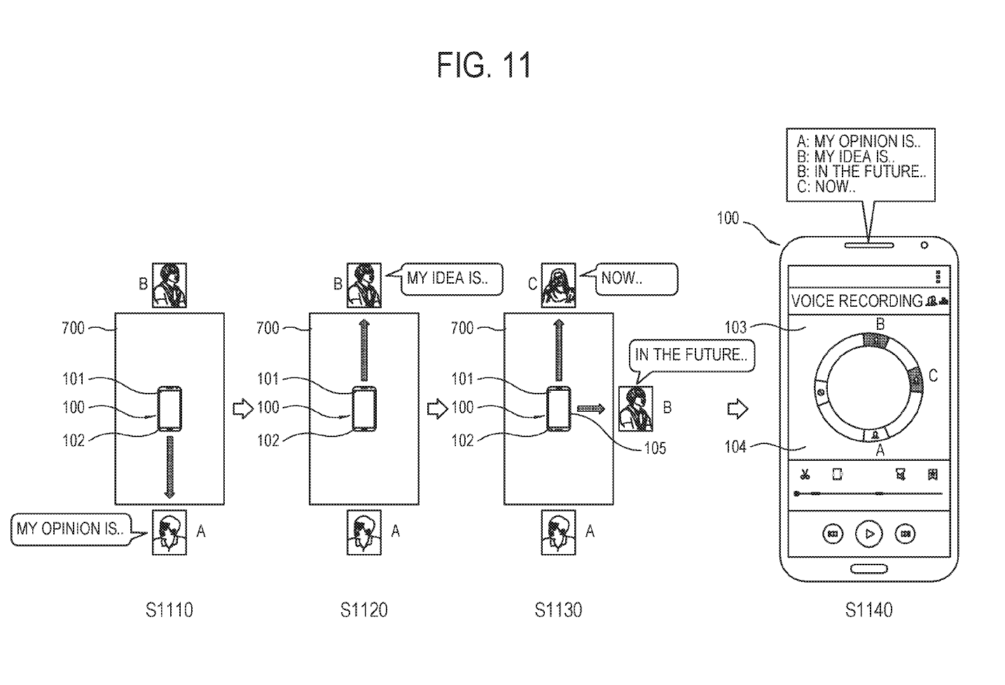

Referring to FIG. 11, as in FIG. 8, in the minute creation mode, the electronic device 100 separates and stores received voices according to utterers based on utterance locations and utterer information of the utterers A and B (S1110, S1120). In other words, a voice received to the lower side 102 of the electronic device 100 is stored as a voice of the utterer A and a voice received to the upper side 101 of the electronic device 100 is stored as a voice of the utterer B.

However, as a new utterer C attends the conference, the utterer C and the utterer B come to be located on the upper side 101 and left side 105 of the electronic device 100, respectively. In this case, the controller 180 of the electronic device 100 newly acquires utterer information C about the utterer C based on received voice of the utterer C and identifies utterance location for the utterer C as the upper side 101 of the electronic device 100 (S1130). Accordingly, a voice received to the upper side 101 of the electronic device 100 is separated and stored to be matched to the utterer C. If increasing the number of microphones included in a microphone array by applying a basic principle illustrated in FIG. 3 to a three dimensional space, the present disclosure may be also applied to the three dimensional space. Furthermore, if enough microphones are secured, a location of sound source (a distance to the sound source) may be estimated as well as a direction of sound source in the three dimensional space.

FIG. 4 is a view illustrating a process of correcting an utterance location. In the voice recognition mode or the minute creation mode, the electronic device 100 may receive voices uttered by a plurality of utterers through the voice receiver 122 including the plurality of microphones. In particular, in a conference where the plurality of utterers attend, the electronic device 100 may separate and store the voices uttered by the plurality of utterers according to utterers.

The voice receiver 122 may be provided at areas different from each other in the electronic device 100 to receive the voices from the plurality of utterers. Since the voice receiver 122 may be provided with at least one microphone, the voice receiver 122 may estimate utterance directions and utterance locations of an uttered voice.

Based on the voices of the plurality of utterers received by the voice receiver 122, the information acquirer 190 may acquire utterer information by utterers according to unique voice frequency bands and types of sound wave that the utterers have, respectively.

Based on utterance locations of the plurality of utterers identified using directivities of the voices received by the voice receiver 122 and the utterer information acquired by the information acquirer 190, the electronic device 100 may store the received voices in the storage 160 matching to the plurality of utterers, who utters corresponding voices, respectively.

Referring to FIG. 4, in a first state S410, the electronic device 100 is placed on a X-Y plane, and an utterer A and an utterer B are positioned at an utterance location A (for example, 15 degrees) and an utterance location B (for example, 60 degrees) from an axis X with respect to a center of the electronic device 100, respectively. The controller 180 of the electronic device 100 may find the utterance locations A and B of the utterers A and B based on directivities of voices of the utterers A and B received by the voice receiver 122.

Also, the information acquirer 190 of the electronic device 100 may acquire utterer information A about the utterer A based on a voice uttered by the utterer A. For example, the information acquirer 190 acquires the utterer information A about the utterer A based on a unique voice frequency band and a unique type of sound wave of the utterer A. Likewise, the information acquirer 190 utterer information B about the utterer B.

Accordingly, the controller 180 matches the utterance location A to the utterer information A and stores a voice received from the utterance location A as a voice of the utterer A. Likewise, the controller 180 matches the utterance location B to the utterer information B and stores a voice received from the utterance location B as a voice of the utterer B.

As described above, the controller 180 may separate and store the voices received through the voice receiver 122 according to utterers in the storage 160 and the stored voices may be reproduced by the acoustic output 153 according to an input inputted through the user input 130 from the user.

Further, the controller 180 may convert the separated and stored voices into text files and store the converted text files in the storage 160. The text conversion is performed in real time, and the separated voices are converted to insert the utterer information therein. The utterer information is information about the utterers and, for example, in the converted text files may be inserted utterer's names or the like. The text files may be displayed on the display 151 of the electronic device 100 according to an input inputted through the user input 130 from the user or transmitted in the form of a short message service (SMS) and multimedia messaging service (MMS) to external devices.

Also, the controller 180 may arrange and store the text files by created times according to an input inputted through the user input 130 from the user.

FIG. 5 is a view illustrating a process of converting a voice into a text. Referring to FIG. 5, the controller 180 may separate voices A and B of utterers A and B and convert the separated voice A and B into text files. At this time, the utterers of the voices are analyzed using utterer information, and the utterers, which correspond to the analyzed utterer information are presented in texts.

The utterer information is table values for voice frequency bands and types of sound wave of utterers provided in advance. If the voice frequency bands and the types of sound wave of the utterers provided in advance are coincided with voice frequency bands and types of sound wave of the separated voices, utterer information included in the table values is converted into and presented in texts.

However, in most cases, since the utterer information is not provided in advance, it will not come to know who the utterers are. At this time, the controller 180 identifies utterance locations of the utterers using the directivities of the received voices and matches the received voices to utters, which utter corresponding voices, based on the identified utterance locations and the utterer information.

In a related art, since utterers are identified according to an order where voices are received through the voice receiver 122, an accuracy in separating the voices of the utterers is low. However, the electronic device 100 according to an exemplary embodiment takes account of even the utterance locations of the utterers, thereby increasing the accuracy in dividing the voices of the utterers.

Referring again to FIG. 4 to explain the problem of the related art in more detail, if the related art electronic device 100 is changed in location or angle, utterers should be identified according to an order where voices are received after the change and thus it was uncertain whether voices of the utterers separated before the change are identical to voices of the utterers separated after the change.

For example, according to the related art, in the first state S410, the related art electronic device 100 stores voices of utterers A and B to match to utterer information A and B, respectively, according to an order where the voices are received thereto. As in a second state S420, if the electronic device 100 is rotated counterclockwise in an angle of 45 degrees after a preset time elapses, unique voice frequency bands and types of sound wave of the utterers vary. Thus, the related art electronic device 100, which does not take account of the rotation, recognizes voices of the utterers A and B received after the rotation as voices of new utterers C and D, respectively, and stores the voices of the utterers A and B as the voices of the utterers C and D, respectively, thereby resulting in severance and discontinuity of voice separation.

However, according to an exemplary embodiment, in the first state S410, the controller 180 of the electronic device 100 identifies utterance locations A and B based on directivities of voices of the utterers A and B, respectively, and stores matching the voices of the utterers A and B to the utterers A and B based on the identified utterance locations A and B and utterer information A and B, respectively. As in a second state S420, even if the electronic device 100 is rotated counterclockwise in an angle of 45 degrees and thus unique voice frequency bands and types of sound wave of the utterers vary, the controller 180 may correct the utterance locations A and B to accommodate the rotated angle to, thereby maintain continuity of voice separation.

In other words, since in the first state S410, the electronic device 100 receives the voice of the utterer B from a direction in a positive angle of 60 degrees from the axis X, the utterance position B has corresponded to the direction in the positive angle of 60 degrees. However, since in the second state S420, the electronic device 100 receives the voice of the utterer B from a direction in a positive angle of 15 degrees from the axis X, the utterance position B is corrected to correspond to the direction in the positive angle of 15 degrees.

FIG. 6 is a flowchart illustrating a process of receiving a voice. Referring to FIG. 6, the process may include receiving voices of a plurality of utterers by the voice receiver 190 of the electronic device 100 (S610), acquiring utterer information about the plurality of utterers who utters the voices based on the received voices by the information acquirer 190 of the electronic device 100 (S620), identifying utterance locations of the plurality of utterers based on the received voices by the controller 180 of the electronic device 100 (S630), and storing the received voices to match to the plurality of utterers, which utter corresponding voices, respectively, based on the identified utterance locations and the acquired utterer information by the controller 180, to store in the storage 160 (S640). With this, the voices uttered by the plurality of utterers may be separated and stored according to utterers. Here, even if the electronic device 100 is changed in location and angle and thus the utterance locations of the plurality of utterers vary, the controller 180 may correct the utterance locations of the plurality of utterers to accommodate the changed location or angle.

On the other hand, the present disclosure may be implemented as a computer readable recording medium in which a program for performing a control method of the electronic device 100 is recorded, the program including receiving voices of a plurality of utterers; storing the voices of the plurality of utterers; acquiring utterer information about the plurality of utterers who utters the voices, respectively; and storing the received voices to match to the plurality of utterers, which utter corresponding voices, respectively, based on utterance locations of the plurality of utterers and the acquired utterer information.

FIG. 7 is a flowchart illustrating a process where the electronic device 100 stores and reproduces a voice. Referring to FIG. 7, it is assumed that the electronic device 100 is set up in the voice recognition mode or the minute creation mode according to an input inputted through the user input 130 from the user and upper side 101 and lower side 102 of the electronic device 100 are placed on a table 700 to face utterers B and A, respectively. Accordingly, the electronic device 100 may acquire utterance locations and utterer information based on voices of the utterers A and B, and separate and store the received voices according to utterers based on the acquired utterance locations and utterer information.

For example, if the voice receiver 122 receives a voice of the utterer A located toward the lower side 102 of the electronic device 100, the information acquirer 190 acquires utterer information A of the utterer A based on a voice frequency band and a type of sound wave of the utterer A. The controller 180 identifies a utterance location A using a directivity of the voice of the utterer A, and stores the voice of the utterer A in the storage 160 to match to the utterer A based on the identified utterance location A and the acquired utterer information A (S710). In the same manner, the controller 180 matches a voice of the utterer B to the utterer B to store in the storage 160 (S720). Accordingly, in the voice recognition mode or the minute creation mode, the electronic device 100 may separate received voices according to utterers and store the separated voices as minutes in the storage 160.

Here, the electronic device 100 may execute a minute reproducing mode for reproducing the minutes stored in the storage 160 according to an input inputted through the user input 130 from the user (S730). If an application corresponding to the minute reproducing mode is executed by the user, a list about a plurality of stored minutes is displayed, and if a minute the user wants to reproduce is selected from the list, a screen, which indicates the utterance locations of the utterers, is displayed on the display 151. In other words, since in the minute creation mode, the utterer B and the utterer A have been located toward the upper side 101 and the lower side 102 of the electronic device 100, respectively, the controller 180 controls the display 151 to display an icon B corresponding to the utterer B and an icon A corresponding to the utterer A on upper end 103 and lower end 104 of the display 151, respectively. When the voice of the utterer A is reproduced, the controller 180 may control the display 151 to display the icon A corresponding to the utterer A to flicker or be distinguished from icons corresponding to other utterers. Also, when the voice of the utterer B is reproduced, the controller may control the display 151 to display the icon B corresponding to the utterer B to be distinguished from icons corresponding to other utterers.

FIG. 8 is a flowchart illustrating a process of storing and replaying a voice according to a related art. Referring to FIG. 8, in a minute creation mode, the upper side 101 and the lower side 102 of the electronic device 100 are placed on a table 700 to face utterers B and A, respectively, as in FIG. 7. Accordingly, the electronic device 100 may acquire utterance locations and utterer information based on voices of the utterers A and B, and separate and store the voices according to utterers based on the acquired utterance locations and utterer information (S810, S820).

However, in the process of the minute creation mode, the upper side 101 and the lower side 102 of the electronic device 100 are upside down to rotate the electronic device 100 in an angle of 180 degree, utterance locations and utterer information after the rotation are not coincided with the utterance locations and utterer information before the rotation, so that voices separated by utterers after the rotation come different from voices separated by utterers before the rotation (S830). In other words, since after the rotation of the electronic device 100, a voice of the utterer B is received to the lower side 102 of the electronic device 100, the received voice of the utterer B is separated into and stored as a voice of the utterer A. Accordingly, in the minute reproducing mode, a malfunction occurs in that while the voice of the utterer B after the rotation is reproduced, an icon A of the utterer A flickers or is displayed on the display 151 (S840).

FIGS. 9 to 14 are views or flow charts illustrating a process where the electronic device 100 stores and reproduces a voice. Referring to FIG. 9, as in FIG. 8, the electronic device 100 separates and stores received voices according to utterers based on utterance locations and utterer information of the utterers A and B (S910, S920). In other words, a voice received to the lower side 102 of the electronic device 100 is stored as a voice of the utterer A and a voice received to the upper side 101 of the electronic device 100 is stored as a voice of the utterer B. At this time, after the upper side 101 and the lower side 102 of the electronic device 100 are upside down to rotate the electronic device 100 in an angle of 180 degree, a voice uttered by the utterer B is a voice received to the lower side 102 of the electronic device 100. Accordingly, the controller 108 corrects an utterance location B of the utterer B to accommodate the rotation of 180 degree, so that the utterance location B of the utterer B comes to be located toward the lower side 102 of the electronic device 100 (S930). Likewise, the controller 180 corrects an utterance location B of the utterer B. After the correction, the controller 180 separates voices received to the lower side 102 and the upper side 101 of the electronic device 100 into voices of the utterers B and A and stores the separated voices as minutes of the utterers B and A in the storage 160.

Accordingly, in the minute reproducing mode, if a minute is selected and reproduced from the stored minutes, an icon A corresponding to the utterer A is displayed on the display 151 to be distinguished from icons corresponding to other utterers when the voice of the utterer A is reproduced, without severance and discontinuity of voice separation (S940).

Referring to FIG. 10, the voice receiver 122 receives voices of a plurality of utterers (S1010). The information acquirer 190 acquires utterer information about the plurality of utterers based on the received voices (S1020). The controller 180 identifies utterance locations for the plurality of utterers based on the received voices (S1030). Also, the controller 180 stores the received voices in the storage 160 to match to the plurality of utterers, which utters corresponding voices, respectively, based on the identified utterance locations and the acquired utterer information (S1040). However, if the electronic device 100 is changed in location or rotated and thus the utterance locations of the plurality of utterers vary, the controller 180 corrects the utterance locations (S1060), and stores received voices in the storage to match to utterers who utter corresponding voices, respectively, based on the corrected utterance locations and the utterer information (S1070). Accordingly, the voices received before and after the utterance locations of utterers are changed may be stored to match to the utterers who utter corresponding voices, respectively.

Referring to FIG. 11, as in FIG. 8, in the minute creation mode, the electronic device 100 separates and stores received voices according to utterers based on utterance locations and utterer information of the utterers A and B (S1110, S1120). In other words, a voice received to the lower side 102 of the electronic device 100 is stored as a voice of the utterer A and a voice received into the upper side 101 of the electronic device 100 is stored as a voice of the utterer B.

However, as a new utterer C attends the conference, the utterer C and the utterer B come to be located on the upper side 101 and left side 105 of the electronic device 100, respectively. In this case, the controller 180 of the electronic device 100 newly acquires utterer information C about the utterer C based on received voice of the utterer C and identifies an utterance location C for the utterer C as the upper side 101 of the electronic device 100 (S1130). Accordingly, a voice received to the upper side 101 of the electronic device 100 is separated and stored to be matched to the utterer C.

Here, since an utterance location for the utterer B is also changed due to the attendance of the utterer C, the controller 180 may identify that the utterance location for the utterer B is changed using the previously acquired utterer information B and a directivity of the voice of the utterer B. Accordingly, the controller 180 may correct the utterance location B of the utterer B from the upper side 101 to the left side 105 of the electronic device 100, and store the voices received to the left side 105 of the electronic device 100 in the storage 160 to match to the utter B based on the corrected utterance location B and the utterer information B.

However, the utterance location B of the utterer B may not be changed in spite of the attendance of the utterer C. In this case, the controller 180 stores the voice of the utterer C to match to the utterer C based on the utterer information C of the new utterer C and the utterance location C identified using the directivity of the voice of the utterer C, and does not require to correct the utterance location B of the utterer B.

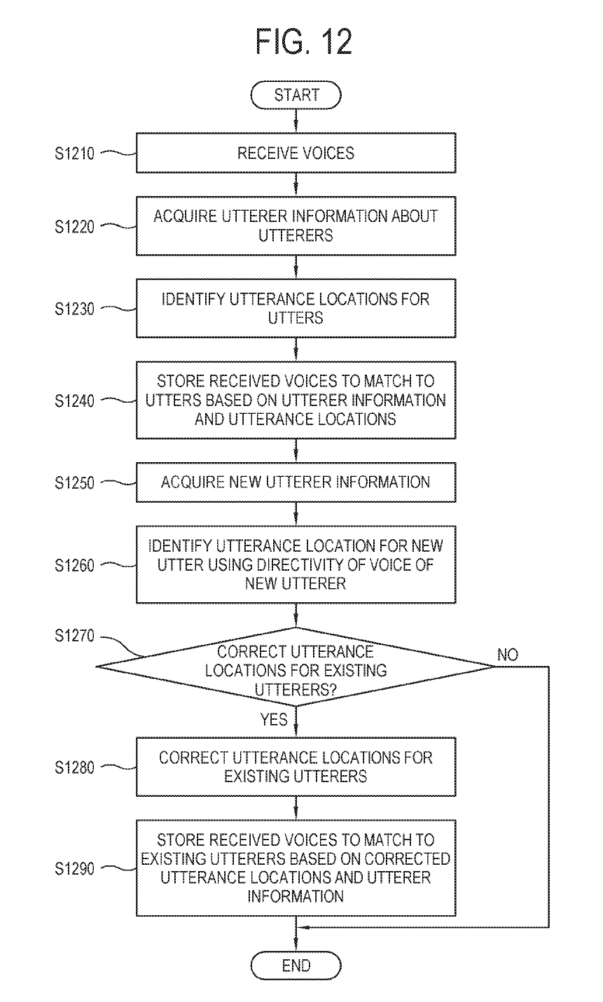

Referring to FIG. 12, the electronic device 100 stores received voices in the storage 160 to match to a plurality of utterers, respectively, based on utterance locations and utterer information about the plurality of utterers (S1210 to S1240). At this time, if a new utterer other than the plurality of existing utterers appears and utters, the information acquirer 190 acquires utterer information about the new utterer (S1250), and the controller 180 identifies an utterance location about the new utterer using a directivity of a voice of the new utterer (S1260).

Here, if the utterance locations of the existing utterers are changed due to the appearance of the new utterer (S1270), the controller 180 corrects the previously identified utterance locations using directivities of the voices of the existing utterers (S1280). The controller 180 may store the voices of the existing utters to match to the existing utterers based on the corrected utterance locations and the previously acquired utterer information about the existing utterers, while storing the voice of the new utterer to match to the new utterer based on the utterance location and the utterer information about the new utterer (S1290).

However, if the utterance locations of existing utterers are not changed in spite of the appearance of the new utterer, the controller 180 may acquire utterer information about the new utterer, and identify the utterance location using the directivity of the voice of the new utterer. Accordingly, there is no need to correct the utterance locations of the existing utterers.

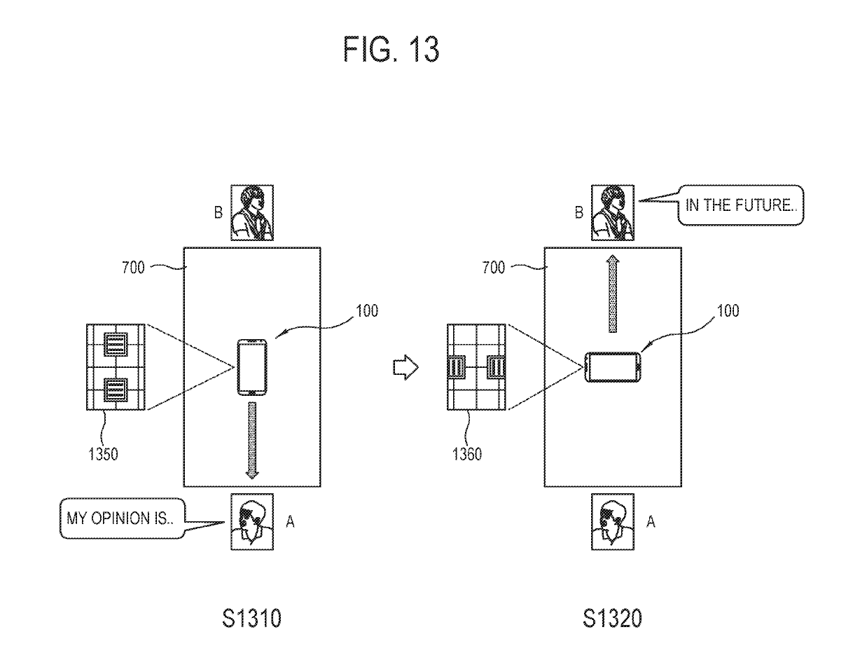

Referring to FIG. 13, the electric device 100 may further include an image acquirer 121 capable of capturing a surrounding image of the electric device 100. The image acquirer 121 may be implemented as at least one camera, and provided at a front surface or a rear side of the case 210 of the electric device 100. The controller 180 of the electric device 100 may set up the electric device 100 in the voice recognition mode or the minute creation mode according to an input from the user through the user input 130. If the electric device 100 is set up in the minute creation mode, the controller 180 control the image acquirer 121 to capture a surrounding image A 1350 of the electric device 100 after a preset time elapses, and stores the captured images A 1350 in the storage 160 (S1310). The controller 180 may identify utterance locations of utterers A and B using directivities of voices received by the voice receiver 122. The controller 180 matches the voices of the utterers A and B to the utterers A and B, respectively, based on the identified utterance locations of the utterers A and B and utterer information about the utterers A and B by acquired by the information acquirer 190 to store in the storage 160.

However, if the electronic device 100 is changed in location and rotated, for example, counterclockwise in an angle of 90 degrees, the voice of the utterer B is received to the left side 105 of the electronic device 100 and thus there is need to correct the utterance location to the utterer B.

If the voice of the utterer B is received from any utterance location other than the previously identified utterance location, the controller 180 identifies that the utterance location to the utterer B is changed, and controls the image acquirer 121 to capture a peripheral image B 1360 of the electronic device 100. The controller 190 may compare the peripheral image B 1360 captured after the rotation with the peripheral image B 1350 captured before the rotation of the electronic device 100 to identify an extent where the electronic device 100 is changed in location or direction, and correct the utterance locations to the utterers A and B based on the identified extent. In other words, voices received to the left side 105 and right side of the electronic device 100 are recognized as voices of the utterers B and A, respectively.

Further, if a new utterer C appears and thus a voice of the utterer C is received, the information acquirer 190 acquires utterer information C about the utterer C and identifies whether the acquired utterer information C is identical with the utterer information A and B of the utterers A and B. In this case, since the utterer information C is different from the utterer information A and B, the controller 180 identifies an utterance location of the utterer C using a directivity of the voice of the utterer C, and stores matching the voice of the new utterer C to the new utterer C based on the identified utterance location C and the acquired utterer information C.

Also, if voices of the utterers A and B are received at utterance locations different from the previously identified utterance locations due to the appearance of the new utterer C, the controller 180 identifies that the utterance locations of utterers A and B are changed, and controls the image acquirer 121 to capture a peripheral image B 1360 of the electronic device 100. The controller 180 compares the captured peripheral image B with the previously captured peripheral image A to identify corrected utterance locations of the utterers A and B. Accordingly, the controller 180 stores the voices of the utterers A and B in the storage 160 to match to the utterers A and B, respectively, based on the corrected utterance locations.

On thither hand, to correct the utterance locations of the utterers, the electronic device 100 may include a sensor part 140 as well as the image acquirer 121. The sensor part 140 may be provided with a gyro sensor or an electronic compass 143. Accordingly, if the electronic device 100 is changed in location or rotated, the gyro sensor or the electronic compass 143 outputs an electric signal for the changed location or rotation angle of the electronic device 100 to the controller 180. Since the controller 180 may correct utterance locations for the plurality of utterers based on the changed location or rotation angle, the controller 180 may store voices of utterers in the storage 160 to match to the utterers who utter corresponding voices, respectively, based on the corrected utterance locations and the utterer information.

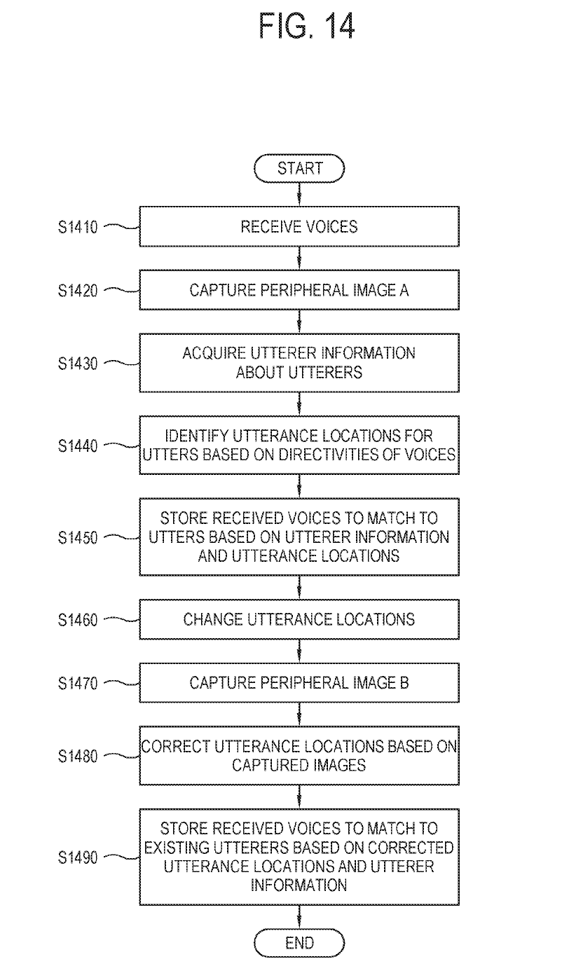

Referring to FIG. 14, the voice receiver 122 of the electronic device 100 receives voices of a plurality of utterers in the voice recognition mode or the minute creation mode (S1410), the image acquirer 121 captures a peripheral image A of the electronic device 100 to store in the storage 160 (S1420), and the information acquirer 190 acquirers utterer information about the plurality of utterers based on the received voices (S1430). The controller 180 identifies utterance locations for the plurality of utterers based on directivities of the received voices (S1440). Based on the identified utterance locations for the plurality of utterers and the utterer information about the plurality of utterers acquired by the information acquirer 190, the controller 180 stores the received voices and the plurality of utterers in the storage 160 in such a manner that the received voices are matched to the plurality of utterers, who utters a corresponding voice, respectively (1450).

However, if the electronic device 100 is changed in location or rotated thus to receive voices of the utterers at changed utterance locations, the controller identifies that the utterance locations are changed (S1460), and controls the image acquirer 121 to capture a peripheral image B 1360 of the electronic device 100 (S1470). The controller 180 may compare the captured two peripheral images 1350 and 1360 thus to identify an extent where the electronic device 100 is changed in location or direction, and correct the utterance locations for the plurality of utterers based on the identified extent (S1480).

Accordingly, the controller 180 may store the received voices in the storage 160 to match to the utterers who utter corresponding voices, respectively, based on the corrected utterance locations and the utterer information (S1490).

On the one hand, if while the electronic device 100 separates and stores an utterer A (an utterance location A and utterer information A) and an utterer B (an utterance location B and utterer information B), a new utterer C appears and thus the voice receiver 121 receives a voice of the utterer C, the information acquirer 190 acquires utterer information to the utterer C based on the received voice of the utterer C and identifies whether the acquired utterer information is identical with the utterer information A and B of the utterers A and B. In this case, since the acquired utterer information is different from the utterer information A and B, the controller 180 identifies an utterance location C based on a directivity of the voice of the utterer C and stores the voice of the new utterer C to match to the utterer C based on the identified utterance location C and the utterer information C. In other words, this is a case that the utterance locations A and B are not changed in spite of the appearance of the new utterer C.

On the other hand, if while the electronic device 100 separates and stores the utterer A (the utterance location A and the utterer information A) and the utterer B (the utterance location B and the utterer information B), the new utterer C appears and thus the utterance location A and the utterance location B are changed, the controller 180 control the image acquirer 121 to capture a peripheral image B 1360 of the electronic device 100. The controller 180 may compare the captured two peripheral image 1350 and 1360 to identify corrected utterance locations of the utterers A and utterer B, respectively. Accordingly, the controller 180 stores the voices of the utterer A and B in the storage 160 to match to the utterers A and B, respectively, based on the corrected utterance locations.

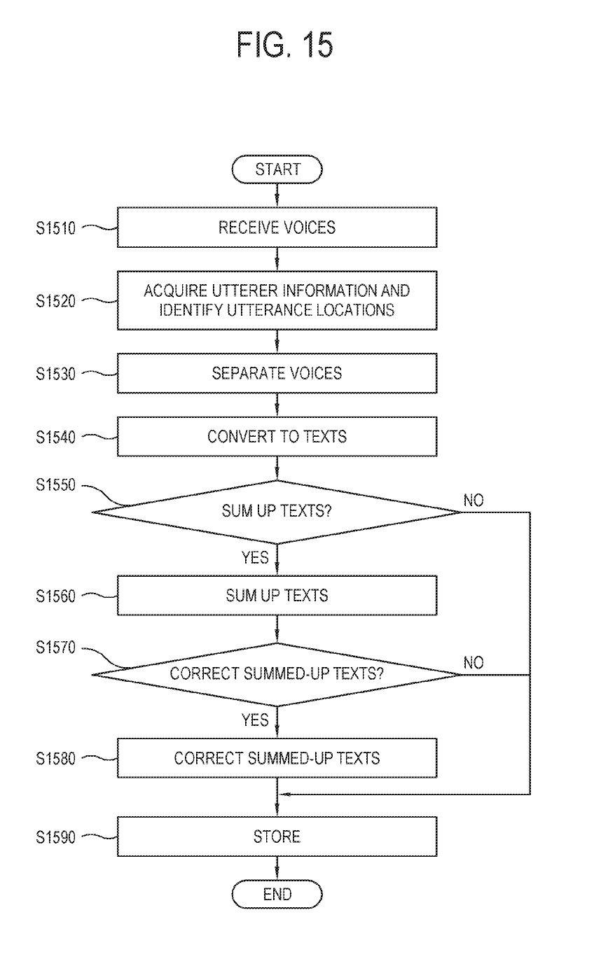

FIG. 15 is a flowchart illustrating a method of creating a minute. The electronic device 100 may be set up in the minute creation mode through the user input 130. If after the electronic device 100 may be set up in the minute creation mode, the voice receiver 122 receives voices from a plurality of utterers (S1510), the information acquirer 190 acquires utterer information about the plurality of utterers who utters the voices, respectively, according to unique voice frequency bands and types of sound wave that the utterers have, respectively, and identifies utterance locations for the plurality of utterers using directivities of the voices received by the voice receiver 122 (S1520). Further, the controller 180 separates the received voices to match to the plurality of utterers, who utters corresponding voices, respectively (S1530) and converts the separated voices into text files (S1540). Also, since data quantity of the converted text files is excessive according to conference agenda, conference time, and the number of conference-goers, the controller 180 displays on the display 151, a user interface (UI) about whether to sum up the converted text files, and identifies whether to sum up the converted text files according to an input inputted through the user input 130 from the user (S1550). If the user wants to sum up the converted text files, the controller 180 may extract words or keywords included in the converted text files to sum up the converted text files within a preset data quantity (S1560). The controller 180 may display a UI about the summed-up text files and whether to correct the summed-up text files on the display 151 (S1570). Also, if the user wants to correct the summed-up text files, the controller 180 may display a UI for modifying, adding and deleting any word or keyword in the summed-up text files, so that the user can create text file summaries complying with her or his intension (S1580). The text file summaries or the converted text files created as described above are classified and stored according to keywords or conference dates in the storage (S1590)

Accordingly, in the minute creation mode, according to a user input, the electronic device 100 may create the text file summaries from the received voices of the plurality of utterers to display on the display 151, or provide the text file summaries stored in the storage 160 in the form of a SMS or MMS to an external device.

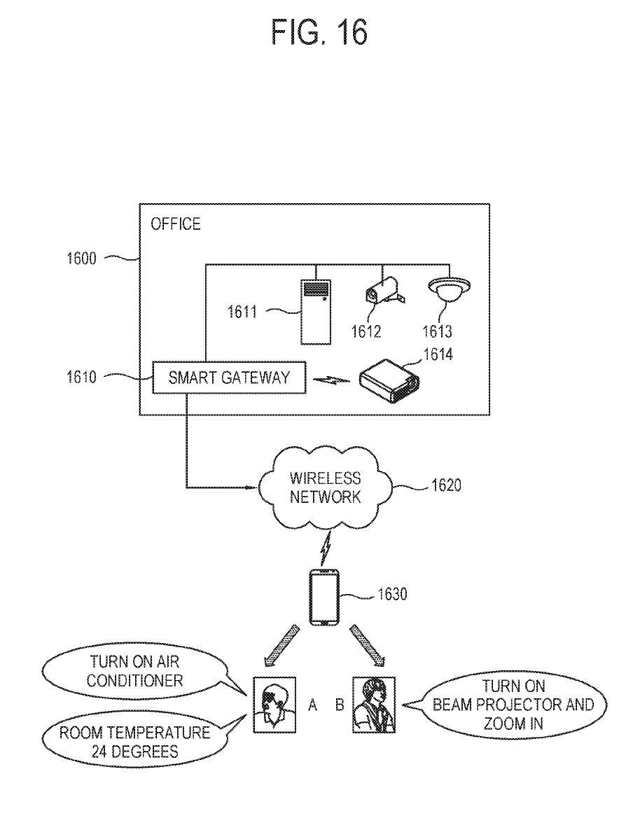

FIG. 16 is a view schematically illustrating a smart network system including an electronic device according to an exemplary embodiment. The smart network system 1600 may include a plurality of smart devices 1611 to 1614, which can control and communicate with one other, and a smart gateway 1610. The smart devices 1611 to 1614 may be located inside and outside an office and include smart appliances, security devices, lighting devices, energy devices, etc. The smart devices 1611 to 1614 may be configured to communicate with the smart gateway 1610, receive a control command from the smart gateway 1610 to operate according to the control command, and transmit requested information and/or data to the smart gateway 1610.

The smart gateway 1610 may be implemented as a separate device or a device having a smart gateway function. For example, the smart gateway 1610 may be implemented as a TV, a hand phone, a tablet personal computer (PC), a set-top box, a robot cleaner, or a PC. The smart gateway 1610 may have communication modules for communicating with the smart devices in a wired or wireless communication manner, register and store information of the smart devices, manage and control operations, supportable functions and statuses of the smart devices, and collect and store required information from the smart devices. The smart gateway 1610 may communicate with the smart devices using wireless communication ways, such as wireless fidelity (WiFi), Zigbee, Bluetooth, near field communication (NFC), z-wave, etc.

In the smart network system 1600, office data communication services, such as internet protocol television (IPTV) through the internet, data sharing, voice over internet protocol (VoIP), and video call, and automation services, such as remote control of smart devices, remote crime prevention, and prevention of disasters may be provided. In other words, the smart network system 1600 connects and controls all types of smart devices used inside and outside the office to and over a single network.

On the one hand, the user may use an electronic device 1630, such as a mobile terminal, in the office to connect to the smart gateway 1610 provided in the smart network system 1600 or to remotely connect to respective smart devices via the smart network system 1600. For example, the electronic device 1630 may be a personal digital assistant (PDA), a smart phone, a feature phone, a tablet PC, a notebook, etc. in which have a communication function, and may be accessed to the smart network system 1600 directly or via network of service providers or the internet.

Here, the electronic device 1630, which can be connected to the smart gateway provided in the smart network system 1600 or remotely connected to the respective smart devices via the smart gateway, may include a plurality of voice receivers 122 provided in areas different for each other in the electronic device 1630 to receive voices from a plurality of utterers, respectively, a storage 160 configured to store the voices of the plurality of utterers, an information acquirer 190 configured to acquire utterer information about the plurality of utterers who utters the voices, respectively, and a controller 180 configured to store the received voices and the plurality of utterers in the storage in such a manner that the received voices are matched to the plurality of utterers, which utters corresponding voices, respectively, based on utterance locations of the plurality of utterers identified using directivities of the voices received by the plurality of voice receivers 122 and the utterer information acquired by the information acquirer 190.

For example, the electronic device 1630 may receive voice control commands for controlling the smart devices from utterers A and B. if the voice control commands of the utterers A and B are received to the electronic device 1630, the electronic device 1630 acquires utterer information A and B about the utterers A and B who utter the voice control commands according to unique voice frequency bands and types of sound wave that the utterers have, respectively, and identifies utterance locations A and B of the utterers A and B using directivities of voices of the utterers A and B. The electronic device 1630 distinguishes matching the voice control commands received to the electronic device 1630 to the utterers A and B, respectively, based on the identified utterance locations A and B of the utterers A and B and the acquired utterer information A and B about the utterers A and B.

Accordingly, the electronic device 1630 distinguishes the voice control commands of the utterers A and B for the smart devices and transmits corresponding control commands for the smart devices to the smart gateway 1610 via a wireless network 1620.

For example, if the utterer A utters a voice control command “turn on air conditioner”, the electronic device 1630 matches the voice control command “turn on air conditioner” to the utterer A based on the utterer information A and the utterance location A and transmits a control command corresponding to the voice control command “turn on air conditioner” to the smart gateway 1610. If the utterer B utters a voice control command “turn on beam project and zoom in” right after the voice control command of the utterer A, the electronic device 1630 matches the voice control command “turn on beam project and zoom in” to the utterer B based on the utterer information B and the utterance location B and transmits a control command corresponding to the voice control command “turn on beam project and zoom in” to the smart gateway 1610.

The smart network system 1600 may process the control commands of the utterers A and B received by the smart gateway 1610 in parallel. For example, the smart network system 1600 may give a control right for an air conditioner 1611 to the utterer A who first utters the voice control command “turn on air conditioner” to the air conditioner 1611, and if receiving from the electronic device 1630 a control command corresponding to a voice control command “room temperature 24 degrees” received from the utterer B, may check with the utterer A whether to perform the control command corresponding to the voice control command of the utterer B. Likewise, the smart network system 1600 may give a control right for a beam projector to the utterer B, and if the utterer A utters any voice control command to the beam projector, may check with the utterer B whether to perform the control command corresponding to the voice control command of the utterer A.

The control right, which is given by the smart network system 1600, may be given based on histories of the voice control commands of the plurality of utterers received to the electronic device 1630. For example, once a control right for the air conditioner 1611 has been given to the utterer A, the smart network system 1600 may continue to give the control right for the air conditioner 1611 to the utterer A before a preset time elapses. Accordingly, if any voice control command is received from other utterer within the preset time, the smart network system 1600 may check with the utterer A whether to perform a control command corresponding to the received voice control command.

While the exemplary embodiments have been shown and described with reference to various embodiments thereof, it will be understood by those skilled in the art that various changes in form and details may be made therein without departing from the present disclosure as defined by the appended claims and their equivalents.

1. An electronic device comprising:
at least one voice receiver configured to receive voices of a plurality of utterers;
a storage configured to store the received voices of the plurality of utterers;
an information acquirer configured to acquire utterer information on the plurality of utterers who utters the voices, respectively; and
a controller configured to store the received voices in the storage to match to the plurality of utterers, who utters corresponding voices, respectively, based on utterance locations of the plurality of utterers and the utterer information acquired by the information acquirer.

2. The device according to claim 1, wherein the at least one voice receiver is provided at at least one area different from each other in the electronic device.

3. The device according to claim 1, wherein the controller is configured to identify the utterance locations of the plurality of utterers using directivities of the voices received by the at least one voice receiver.

4. The device according to claim 1, wherein the controller is configured to correct the utterance locations in response to determining that the utterance locations are changed.

5. The device according to claim 1, wherein the controller is configured to, in response to utterer information different from the acquired utterer information being acquired, add an utterer corresponding to the different utterer information.

6. The device according to claim 5, wherein the controller is configured to identify an utterance location of the added utterer corresponding to the different utterer information, and store a voice of the added utterer in the storage to match to the added utterer based on the utterance location of the added utterer and the different utterer information.

7. The device according to claim 6, wherein the controller is configured to, in response to the utterance locations of the plurality of utterers being changed due to the added utterer, correct the utterance locations of the plurality of utterers.

8. A control method of an electronic device comprising:
receiving voices of a plurality of utterers;
storing the received voices of the plurality of utterers;
acquiring utterer information on the plurality of utterers who utters the voices, respectively; and
storing the received voices to match to the plurality of utterers, who utters corresponding voices, respectively, based on utterance locations of the plurality of utterers and the acquired utterer information.

9. The method according to claim 8, wherein the receiving comprises receiving the voices of the plurality of utterers at least one area different from each other in the electronic device.

10. The method according to claim 8, wherein the storing comprises identifying the utterance locations of the plurality of utterers using directivities of the received voices.

11. The method according to claim 8, wherein the storing comprises correcting the utterance locations in response to determining that the utterance locations are changed.

12. The method according to claim 8, wherein the storing comprises adding, in response to utterer information different from the acquired utterer information being acquired, an utterer corresponding to the different utterer information.

13. The method according to claim 12, wherein the adding comprises identifying an utterance location of the added utterer corresponding to the different utterer information, and storing a voice of the added utterer to match to the added utterer based on the utterance location of the added utterer and the different utterer information.

14. The method according to claim 13, wherein the storing the voice of the added utterer to match to the added utterer comprises correcting, in response to the utterance locations of the plurality of utterers being changed due to the added utterer, the utterance locations of the plurality of utterers.

15. A computer readable recording medium including a program for executing a control method of an electronic device, the control method of the electronic device comprising:
receiving voices of a plurality of utterers;
storing the received voices of the plurality of utterers;
acquiring utterer information on the plurality of utterers who utters the voices, respectively; and
storing the received voices to match to the plurality of utterers, who utters corresponding voices, respectively, based on utterance locations of the plurality of utterers and the acquired utterer information.
